(19) United States
(12) Patent Application Publication
(10) Pub. No.: US 2019/0031353 A1
(43) Pub. Date: Jan. 31, 2019

(54) CONVERTIBLE SEAT WITH LEG REST OR WITHOUT LEG REST AND CONVERSION METHOD

(71) Applicant: Stelia Aerospace, Rochefort (FR)

(72) Inventor: Laurent TEXERAUD, Clavette (FR)

(21) Appl. No.: 15/945,323

(22) Filed: Apr. 4, 2018

(30) Foreign Application Priority Data
Apr. 4, 2017 (FR) 1752931

(51) Int. Cl. B64D 11/06

(52) U.S. Cl. CPC B64D 11/0643; B64D 11/0648

(57) ABSTRACT

A seat includes a sitting surface and a box, including a casing located under a cushion support surface of the sitting surface. The box can be stationarily secured or removably secured to a structure of the sitting surface by means of one or more articulated arm(s). The box includes a set of attachment locations including a first subset in which each attachment location is located opposite a fixed attachment point on the structure, and a second subset in which the fasteners are different from those of the first subset and in which each attachment location is located opposite a point of attachment on an articulated arm when the seat is provided with articulated arm(s). The method for converting a seat without a leg rest into a seat with a leg rest, or vice versa, includes securing the box simultaneously to the structure and to at least one articulated arm.

### CROSS REFERENCE TO RELATED APPLICATION

This application claims priority to, and the benefit of, French Application No. 1752931, filed on 4 Apr. 2017, the disclosure of which is incorporated herein by reference in its entirety.

### BACKGROUND

### 1. Field

The disclosed embodiment belongs to the field of resting seats such as seats used in the layout of passenger spaces in vehicles and more specifically in aircraft.

The disclosed embodiment particularly relates to a seat with a leg rest implemented to provide support for the legs of the occupant of the seat to improve comfort when the seat is in a resting position.

More specifically, the arrangement of the seat structure according to the disclosed embodiment is adapted to allow installation of the leg rest on the seat as an option.

### 2. Brief Description of Related Developments

In the field of passenger transport, in particular aircraft, seats offered to passengers are considered to be equipment with a strong commercial impact.

The airlines operating aircraft are therefore demanding in terms of comfort offered to passengers, but also pay close attention to both equipment purchase price and maintenance costs.

The leg rest is one of the elements of a seat that contributes to the comfort of the passenger by providing him with the possibility of choosing positions more relaxing than the sitting position.

In practice, the leg rest is connected to the seat structure and is adjustable in various positions relative to the sitting surface.

Most often, the position of the leg rest can be adjusted between a stored position, in which the leg rest is not used, and at least one raised position in which the leg rest extends the length of the sitting surface in a forward direction for the comfort of the seat occupant, forming a more or less pronounced angle with the sitting surface.

In a known embodiment, the leg rest consists mainly of a plate, adapted to the desired dimensions of the leg rest, which is covered with a cushion and secured by means of hinges to the seat structure supporting the sitting surface. An actuator, most often electric, placed on the seat structure allows the occupant of the seat to easily change the position of the leg rest according to the positions of other elements of the seat, in particular the sitting surface and the backrest.

In such an arrangement, the structure of the leg rest and that of the sitting surface are highly interdependent and significantly impact the technical definition of the seat according to whether it is a seat without a leg rest or a seat with a leg rest.

The consequences of the presence or absence of a leg rest are all the more important that the seat comprises, at least in the case of aircraft seats, a lifejacket installed most often under the sitting surface whose installation interferes with that of the leg rest and its actuating mechanisms.

It follows from this situation that the modification of a given seat to transform a seat without leg rest into a seat with leg rest, and vice versa, proves to be complex, if not impossible in practice, when the aircraft operator wants to modify the standard of a seat currently used, for example when reassigning a seat or when converting the comfort standard of a cabin.

### SUMMARY

The presently disclosed embodiment provides a solution for a quick and inexpensive conversion of the comfort of a seat by mounting or not a leg rest, or by dismantling the leg rest installed.

The seat comprises a sitting surface, said sitting surface comprising a support surface for a seat cushion secured to the structure of said seat, and a box, said box having a casing placed under the support surface of the seat cushion.

According to the disclosed embodiment, the box can be mounted so as to be secured to the structure of the seat or to be movable relative to the structure of the seat by means of one or more arms articulated about an axis of rotation, oriented in a lateral direction Y, with respect to the structure of the sitting surface.

In addition, the box includes a set of attachment locations, said set comprising:

a first subset of a plurality of attachment locations wherein each attachment location is located, in a stored position of the box, opposite a fixed attachment point on the seat structure; and

a second subset of a plurality of attachment locations, all distinct from the attachment locations of the first subset, wherein each attachment location is located in the stored position of the box, opposite an attachment point on an articulated arm relative to the structure of the sitting surface when the seat is provided with one or a plurality of articulated arms for supporting said box.

Thus, the box can be mounted either fixed or articulated with respect to the structure of the sitting surface according to the functions designed for the box in the seat, simple fixed box or mobile support in addition to a storage volume, providing the possibility to be attached to the movable assembly of the articulated arms by being simultaneously connected to the structure of the sitting surface to allow the conversion between the two positions of the seat.

When the seat is in use, the box is advantageously secured to the structure of the sitting surface by one or more fasteners placed at the attachment locations of the first subset, excluding the attachment locations of the second subset.

This configuration allows to avoid interference with the assembly when articulated arms are implemented.

Advantageously in this case, a passive front plate, forming all or part of the seat cushion support surface, is secured to the structure of the sitting surface on the side of a front edge of the sitting surface, such a passive front plate being thus secured to the structure of the sitting surface independently of the box also secured to the structure of the sitting surface.

When the seat comprises one or more articulated arms, while the seat is in use, the box is attached to the one or more articulated arms by fasteners placed at the attachment locations of the second subset, excluding the attachment locations of the first subset.

This configuration allows to avoid interference when mounting the box directly onto the structure of the sitting surface.

In such case, an active front plate, comprising a support plate forming all or part of the cushion support surface of the sitting surface, is advantageously secured to the structure of the sitting surface on the side of a front edge of the sitting surface, one or more hinged or articulated arms being secured to said support plate along with an actuator, arranged to change a position of the box attached to the one or more articulated arms.

Thus, all the active and mobile parts to ensure the movements of the box are grouped into a single component of the seat, the active front plate being easily assembled and dismounted.

When the box is thus removably mounted, at the front of the seat, the casing of the box is advantageously closed by a leg rest secured to a front face of said box, the position of said leg rest relative to the sitting surface resulting from the position of said adjustable box by the actuator.

It is thus possible to implement a leg rest which includes a part of the supporting structure formed by the box used independently of the leg rest function while making the box accessible by removing the leg rest or, on the contrary, by protecting the contents of the box by the rest legs forming a lid.

Whether a leg rest is implemented or not, when the seat does not have a leg rest, it preferably comprises a passive front plate, and when the seat does have a leg rest, it comprises an active front plate.

To adapt simply to the presence or absence of a leg rest, the structure of the sitting surface has mounting slots for mounting alternately a passive front plate or an active front plate.

Even more advantageously, and to limit the number of attachment points on the structure of the sitting surface, the same mounting housings of the structure of the sitting surface are implemented to fix to said structure of the sitting surface, by means of removable fasteners, alternatively the passive front plate and the active front plate, the passive front plate and the active front plate being mechanically interchangeable.

In one aspect of the disclosed embodiment, the seat has at least one rear plate forming a portion of the cushion support surface of the sitting surface, said plate being attached to the sitting surface structure independently of the passive front plate or the active front plate, as appropriate.

The dimensions of the passive front plate and the active front plate are thus limited and their support functions, determined by the active front plate, do not require that a plate used for the entire support surface of the cushion of the sitting surface be interchangeable for conversion needs, and the stability of the sitting surface structure is ensured when the front plate is disassembled to convert the seat.

The disclosed embodiment also relates to a method for converting a seat according to one of the preceding claims wherein a seat without a leg rest is converted into a seat with a leg rest or, conversely, a seat with a leg rest is converted into a seat without a leg rest, said conversion method comprising a step in which the box is secured simultaneously to the structure of the sitting surface and to at least one articulated arm relative to the structure of the sitting surface.

The implementation of such a step during the conversion avoids that the box be removed from the seat and ensures proper positioning of the various elements during the conversion.

The conversion of a seat without a leg rest into a seat with a leg rest involves the following steps:

disassembling a passive front plate attached to the structure of the sitting surface; then

fixing an active front plate, equipped with a leg rest actuator and one or more articulated arms, to the structure of the sitting surface at the location left free by the passive front plate dismantled in the previous step; then

attaching the articulated arms to the box, held directly attached to the structure of the sitting surface; then

removing the fasteners which maintain the box secured directly to the structure of the sitting surface.

The conversion of a seat with leg rest into a seat without a leg rest involves the following the steps:

placing the leg rest in a stored position; then

directly securing the box to the structure of the sitting surface; then

disconnecting the articulated arm(s) from the box; then

removing an active front plate, supporting an actuator of the leg rest and articulated arms; then

attaching the passive front plate to the structure of the sitting surface in the location left free by the active front plate dismantled in the previous step.

The conversion of a seat is thus obtained by a limited number of operations which at no time compromise the integrity and stability of the seat structure.

### BRIEF DESCRIPTION OF THE FIGURES

The disclosed embodiment is described with reference to the figures which are given by way of nonlimiting example of an aspect of the disclosed embodiment and which schematically represent:

FIG. 1a: a partial isometric view of the structure of a seat according to the disclosed embodiment, seen from the front of the seat, without its coverings and cushion, in a configuration of the seat without leg rest, inset (a) with the covered structure;

FIG. 1b: a partial isometric view of the seat structure of FIG. 1a, in a configuration of the seat with leg rest;

FIG. 2a: a partial isometric view and exploded view of the structure of the seat sitting surface in the configuration of FIG. 1a, without the leg rest;

FIG. 2b: a partial isometric view and exploded view of the structure of the seat sitting surface in the configuration of FIG. 1b, with the leg rest;

FIG. 3a: an isometric view of the passive front plate of the seat sitting surface of FIG. 1a, isolated from the seat;

FIG. 3b: an isometric view of the active front plate of the seat sitting surface of FIG. 1b, isolated from the seat, which is equipped with an actuator for modifying the position of the leg rest;

FIG. 4a: a perspective view of a lifejacket box in position under the sitting surface of the seat in the configuration of FIG. 1a, attached directly to the seat structure, the closure panel being removed and revealing the inside of the box shown empty;

FIG. 4b: a sectional view in a longitudinal vertical plane of a portion of the seat comprising the sitting surface and the support structure of the sitting surface according to the configuration without the leg rest of FIG. 4a;

FIG. 5a: a perspective view of a leg rest of the seat of FIG. 1b in the partially raised position, the panel covered with a cushion forming the surface of the leg rest being positioned on the box and closing the box;

FIG. 5b: a sectional view in a longitudinal vertical plane of a portion of the seat comprising the sitting surface and the support structure of the sitting surface according to the configuration with leg rest of FIG. 5a, the leg rest being in the stored position;

FIG. 5c: a sectional view in a longitudinal vertical plane of a portion of the seat comprising the sitting surface and the support structure of the sitting surface according to the configuration with leg rest of FIG. 5a, the leg rest being in a partially raised position.

In the different figures, the drawings are not necessarily represented with the same scale.

### DETAILED DESCRIPTION

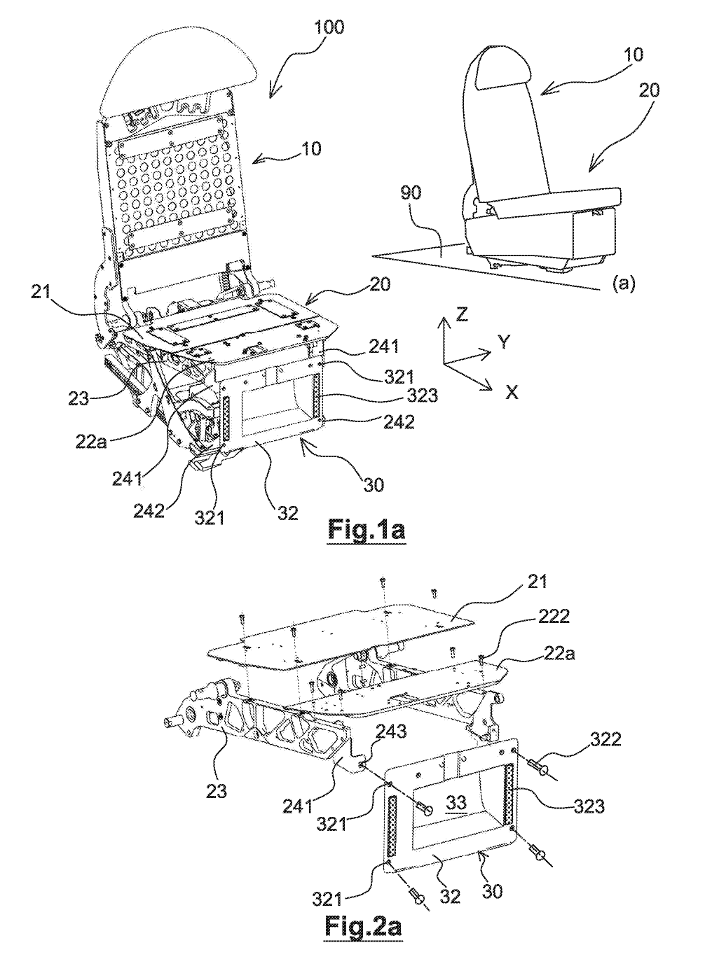

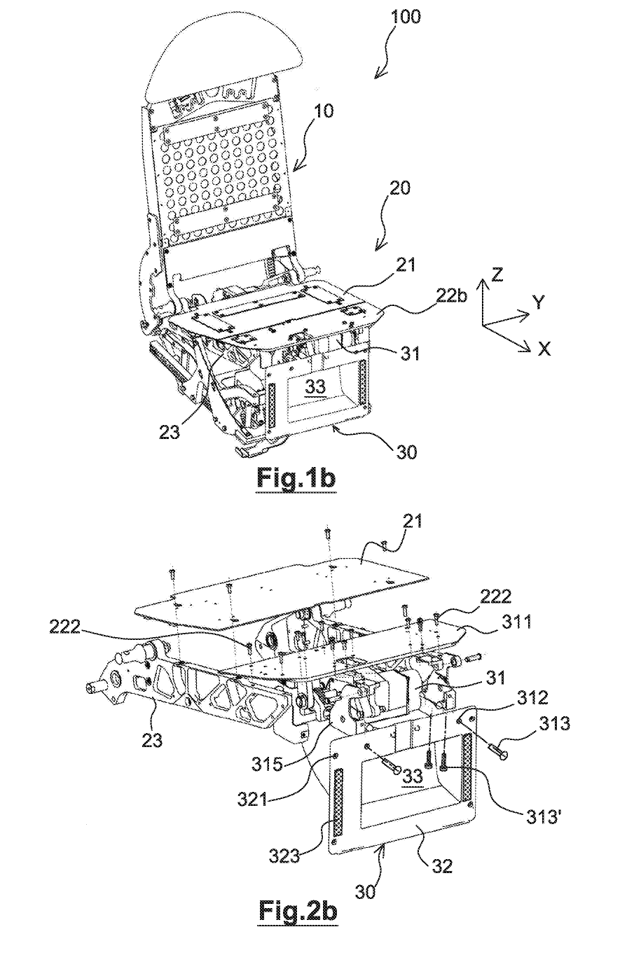

FIGS. 1a and 1b illustrate an example of a structure 100 of a seat according to the disclosed embodiment in two configurations: without leg rest, FIG. 1a, and with leg rest, FIG. 1b.

For the purposes of the description, a conventional axis system will be used with a horizontal axis X oriented positively towards the front of the seat, a vertical axis Z oriented positively upwards, and a lateral axis Y, perpendicular to a plane defined by the horizontal and vertical directions, oriented positively towards the left of the seat.

The terms front, back, high, low and the equivalent terms or expressions refer to the positions or directions that would be given to them by a seat occupant while seated in said seat. Thus, the front of the seat corresponds to the direction towards which the occupant seated in the seat looks, without turning his head, regardless of the orientation that the seat may have with respect to the direction of movement of a vehicle in which it is installed.

The seat comprises a sitting surface 20 and a backrest 10, whose structures are only partly shown in FIGS. 1a and 1b. In said figures, the seat is simplified and stripped of accessories not necessary for the presentation of the disclosed embodiment or its understanding, for example armrests or a system of settings of the backrest, which may or may not be present on a seat of the disclosed embodiment.

The structure 100 provides the seat with the strength and rigidity necessary to support the weight of an occupant in all intended uses of said seat and allows to transmit the forces to another structure that must carry the seat, for example the floor 90 of a vehicle.

In the present description, and except in the case of the leg rest, the relative movements of the sitting surface 20 and the backrest 10, or other moving parts of the seat, or the devices implemented to ensure such possible movements and their locking means will not be described.

FIG. 1a shows a seat structure 100 according to the disclosed embodiment in the case where the seat has no leg rest.

The structure of the sitting surface 20 mainly comprises two beams 23 supporting a rear plate 21 of the sitting surface and a passive front plate 22a of the sitting surface.

The passive front plate 22a is located on a front edge of the sitting surface. When the seat is in use, the plates are covered with a cushion on the sitting surface, as illustrated on the inset (a) of FIG. 1a and are not visible by a seat occupant.

The structure of the sitting surface also comprises supports 241, 242 to which is secured a box 30, intended, in the application of an aircraft seat for example, to accommodate a lifejacket.

The box 30 comprises a front plate 32 and a casing 33 forming a single piece.

The front plate 32 comprises a first subset of a plurality of locations, which, in this case, are holes 321 for fasteners, fastening screws 322, attaching the box at attachment points of the supports 241, 242 so that the casing 33 is held in a fixed position relative to the structure of the sitting surface under a cushion support surface of the sitting surface determined by the upper faces of the rear plate 21 and the passive front plate 22a.

In FIG. 1a, the lifejacket is not shown.

The front plate 32 comprises, on a front face, strips 323 of a self-gripping fabric to hold a closure panel, not shown in FIGS. 1a and 1b, of the casing 33, and can be pulled open by an occupant of the seat when this occupant must access the lifejacket placed in said casing.

As is understood from the description above, the box 30 is held in a fixed position on the structure 100 of the seat, and more particularly on the structure of the sitting surface 20 by the supports 241, 242.

As also illustrated in FIG. 2a, the box 30, held by the screws 322 passing through the holes 321 and in engagement with the captive nuts 243 integral with the supports 241, 242, can easily be disassembled or reassembled in this configuration of the seat without a leg rest.

The captive nuts 243 are advantageously self-locking nuts to prevent unwanted loosening under the effect of vibrations.

The closure panel, not shown, when in place, protects the lifejacket placed in the casing 33 and provides the finishing touch of the portion of the seat under the front edge of the sitting surface by acting as a panel dressing.

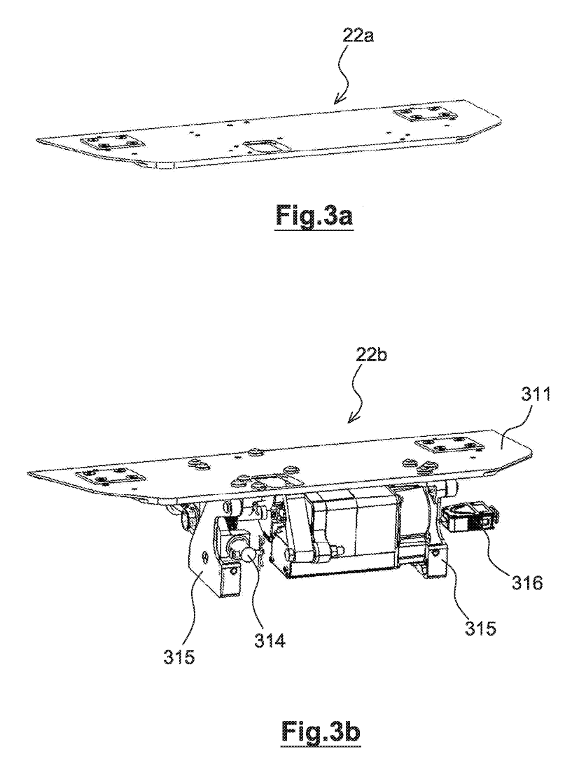

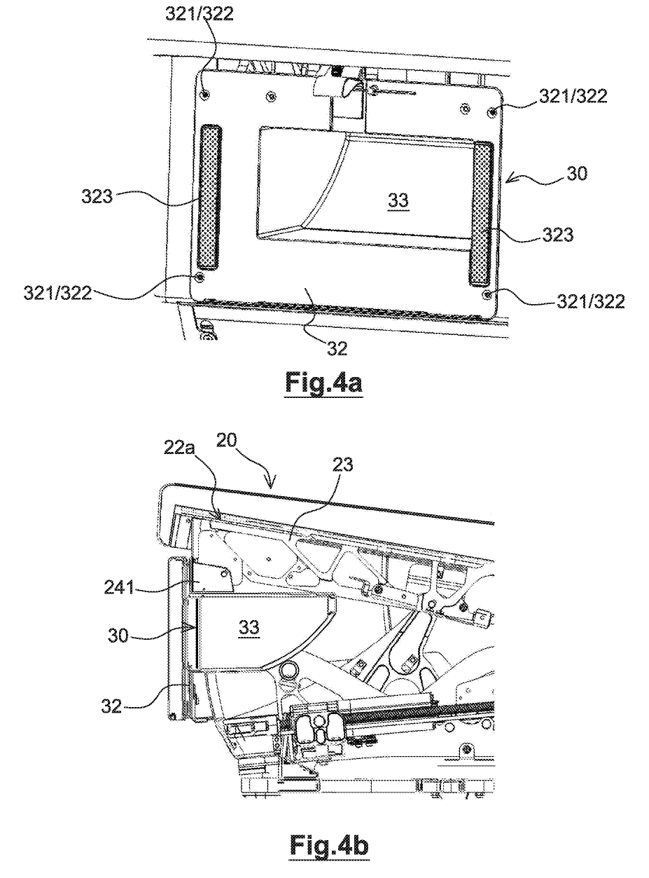

It should be noted that the box 30 is secured to the structure of the sitting surface 20 independently of the passive front plate 22a, shown isolated in FIG. 3a, which is also removably attached to the structure of the sitting surface. It should be understood here that the box and the passive front plate can each be disassembled and reassembled on the structure of the sitting surface independently of one another.

As illustrated in FIG. 2a, the front plate is secured by screws to the beams 23 to take up the forces applied to the sitting surface when in use.

It should also be noted that the passive front plate 22a is secured to the structure of the sitting surface independently of the rear plate 21. It is thus possible to disassemble and reassemble said passive front plate without disassembling the rear plate which, in addition to the simplification of assembly and reassembly operations, avoids destabilizing the structure of the sitting surface when the passive front plate is disassembled, and thus avoids the need for special tooling to ensure the correct positioning of the various elements of the structure during reassembly.

As illustrated in FIG. 3a, the passive front plate 22a, when used for a seat without a leg rest, is particularly simple and similar to a regular flat plate which in this case ensures the continuity of the reference plane of the sitting surface in front of the rear plate 21.

Referring now to FIGS. 1b and 2b, the seat has an adjustable leg rest.

The seat structure 100 of FIG. 1b comprises the same main components, in particular the backrest 10 and the sitting surface 20, and in the same arrangement as for the seat of FIG. 1a without a leg rest. In practice, the structure of the seat with leg rest is identical to the structure of the seat without leg rest, outside the possible options of the seat, except for parts specific to the leg rest, parts which are detailed below.

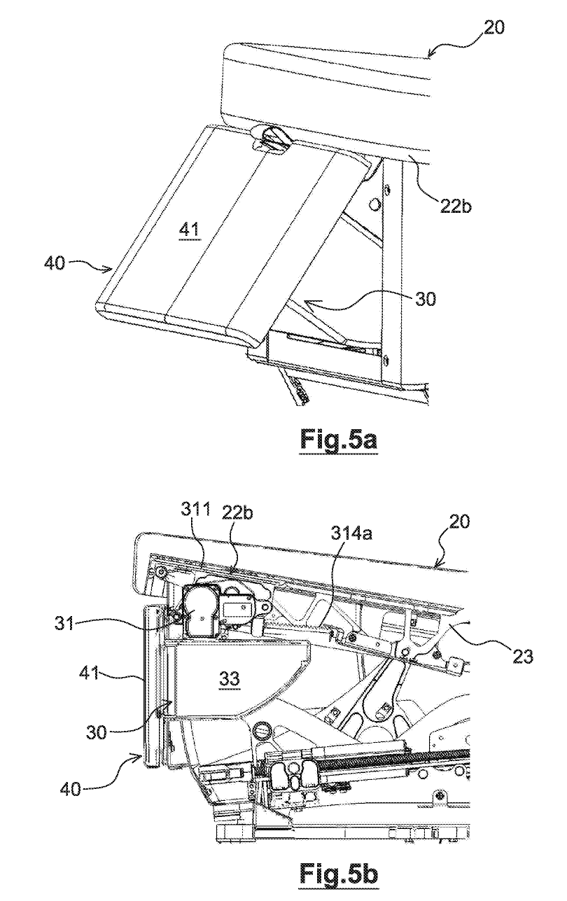

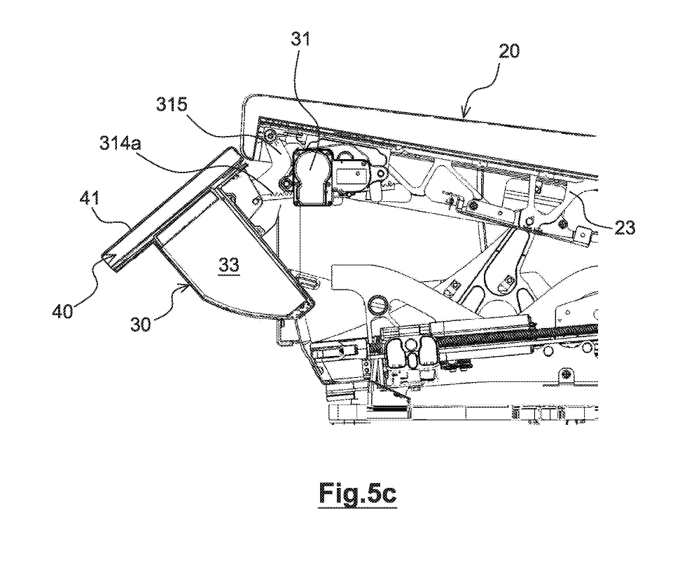

The seat of FIG. 1b comprises a leg rest 40 and is illustrated in the partially raised position shown in the perspective view of FIG. 5a.

It is known that the leg rest is adjustable and can take different positions, including at least one stored position when the leg rest is not used, and at least one raised position or in practice several raised positions.

In the stored position, the leg rest is in a position that allows the occupant of the seat to be in the seated position without hindrance at the level of his legs. In the case of the seat of FIG. 1b, a resting surface 41, visible in FIG. 5a, of the leg rest on which the occupant of the seat places his legs, when said leg rest is in a raised position, is substantially vertical under a front portion of the reference surface of the sitting surface, as shown in FIG. 5b.

In the raised position, the resting surface 41 is projected towards the front of the sitting surface, as illustrated in the section of FIG. 5c, by taking a position more or less close to a horizontal plane to form a surface substantially in continuity with a top of the cushion of the sitting surface, forming a more or less pronounced angle, or a flat angle in some instances.

In addition, the leg rest 40 is, under normal conditions of use, secured to the box 30 for which it serves as a closure panel for holding the lifejacket, or another object, protected in casing 33. For example, the leg rest covers, at least partially, the front plate 32 of the box 30 on which front plate it is held by means of self-gripping tissue strips 323.

According to a feature of the seat of FIG. 1b, the position of the leg rest is modified by changing the position of the box 30 which is in this configuration and is integral with and removably secured to said structure of the sitting surface 20.

To modify in a controlled manner the position of the box 20 with respect to the structure of the sitting surface, said box is no longer secured directly to the structure of the sitting surface by the supports 241, 242, but is integral with an active front plate 22b.

As illustrated in FIG. 2b of the exploded partial structure of the sitting surface, the front plate of the sitting surface 22b comprises a support plate 311, an actuator 31 and articulated arms 315, at least one arm and preferably two arms, as in the example shown.

As shown in FIG. 3b of the active front plate 22b, isolated and illustrated in an orientation consistent with its orientation when attached to the structure of the sitting surface, illustrated in FIGS. 2a to 2b, the actuator 31 and the articulated arms 315 are attached to the support plate 311 on a lower face of said support plate. The articulated arms, whose hinge pins are aligned on the support plate, are arranged to allow an angular movement of said articulated arms in a vertical longitudinal plane XZ, so that the box 30 attached to the articulated arms can follow an oscillating front-back movement.

Preferably, the hinge pins are located near the support plate 311 so that the hinged arms have a pendulum movement which leads to an upward movement of the box and a rotation of a front face of said box in order to bring said front face closer to a horizontal plane when said box is moved forward.

In the aspect of an electric actuator, the actuator 31 is, for example, a geared motor, comprising a motor that moves a piston 314, for example by means of a rack 314a, visible in FIGS. 5b, 5c, to drive the box 30 in a forward rotation to deploy the leg rest, or in a backward rotation to bring it to the stored position.

In this configuration of the seat, it is excluded that the box 30 be secured directly to the fixed structure of the sitting surface so the screws 303, implemented to fix said box in the case of a seat without leg rest, are necessarily absent, even when, as in the case illustrated in FIGS. 1a and 1b, the supports 24a, 24b are stored in the seat with leg rest.

The front plate 32 comprises a second subset of a plurality of locations, which in this case are holes 312 for fasteners, fixing screws 313 securing the box 30 to the articulated arms 315 so that the casing 33 is located in the stored position of the leg rest under the cushion support surface of the sitting surface.

To secure the box 30 to the articulated arms 315, the attachment locations of the second subset are located on the box 30 to correspond to attachment points on said articulated arms, for example, captive nuts, or tapped holes, of said articulated arms.

In addition, the attachment points of the articulated arms 315 are located at different locations of the attachment points on the supports 241, 242 of the structure of the sitting surface, and thus the attachment locations of the second subset are located on the box 30, differently from the attachment locations of the first subset.

Another feature is that the active front plate 22b, implemented for the seat with the leg rest, is interchangeable with the passive front plate 22a, implemented for the seat without leg rest, thus presenting advantageously, but not necessarily, the same positions of the holes on said passive front plate and on the support plate 311 to use the same attachment points on the structure of the sitting surface.

Advantageously, as in the examples illustrated and particularly apparent in FIGS. 2a and 2b, the support plate 311 of the active front plate is identical to the passive front plate 22a, the passive front plate and the active front plate being distinguished only by the accessories and equipment with which they are equipped.

Thus, with the same seat structure, two seat models are obtained with a different front plate, a first model without leg rest following the configuration of FIG. 1a with the passive front plate 22a and in which the box 30 is secured in a stationary position by supports on the structure of the sitting surface, and a second model with leg rest according to the configuration of FIG. 1b with the active front plate 22b which comprises an actuator and articulated arms to which the same box 30 is secured to serve as mobile support for the adjustable leg rest.

Preferably, the box 30 is in the same position in an axis system connected to the structure of the sitting surface, on the one hand, when it is attached to the supports 241, 242 in the configuration of the seat without leg rest and, on the other hand, when it is attached to the articulated arms 315 in the configuration of the seat with leg rest and the leg rest is in the stored position.

The advantages of this arrangement will be apparent from the seat conversion process described later.

The aspect of the disclosed embodiment described in detail may be subject to variations without departing from the principles of the disclosed embodiment.

In particular, the shapes of the supports, the types and numbers of fasteners used and the type of actuator may be different from the illustrated example. In general, the seat structure may be different from that shown in the aspect of the disclosed embodiment provided that it allows the mounting of a front plate of the sitting surface according to the principles of the disclosed embodiment associated with a box under a front part of the sitting surface.

The kinematics of the articulated arms may also be different from that of the illustrated example as long as it allows leading to similar movements of the leg rest during deployment and storage of said leg rest.

In one aspect of the disclosed embodiment, the structure of the sitting surface does not include a rear plate and the front plate, passive or active, which is implemented corresponds to the sitting surface.

The seat, depending on the presence or absence of the leg rest, may also include adaptations of secondary elements, such as covering or cushioning, for example to allow access to a command 316 of the actuator 31, said command being advantageously secured to the active front plate 22b.

It should also be noted that the box 30 is presented as a lifejacket box, particularly for application to an aircraft seat, but also that the box can be used to store any product that should remain accessible to the seat occupant. For example, the product may be safety equipment other than a lifejacket, or a personal effect of the seat occupant who, in this case, uses the casing 33 as a storage box.

The closure panel, used or not as a leg rest, can also be maintained by any temporary attachment means for opening and closing the casing box with said closure panel.

An advantage of the seat of the disclosed embodiment is to allow a simple and fast conversion of the seat without leg rest into a seat with leg rest, or vice versa.

One method of converting a seat without a leg rest into a seat with a leg rest comprises the following steps.

Without these operations being specifically related to the method, the seat is prepared beforehand to carry out the conversion. This preparation consists, for example, in placing the seat on a work support, for the comfort and safety of the operators carrying out the conversion, in removing from the seat the non-structural parts of the seat, for example, cushions, covering panels, the casing closure panel 33, the lifejacket in said casing, and in general any element of the seat that may hinder the conversion operations or be damaged during these operations.

In a first step of the conversion, the passive front plate 22a of the seat without a leg rest is disassembled, in the example illustrated in FIG. 1a, simply after having removed the screws 222, namely four screws in the illustrated example, securing said front plate on the beams 23 of the sitting surface.

In a second step of the conversion, the active front plate 22b, comprising the actuator 31 and articulated arms 315, is placed in the position left free by the passive front plate 22a, dismounted in the previous step. Said active front plate is then secured by screws on the beams 23 of the sitting surface as that of the passive front plate, advantageously using the same attachment points.

In a third step of the conversion, the articulated arms 315 are secured to the box 30, which is always held secured to the structure of the sitting surface by the supports 241, 242. In the example of FIGS. 1b and 2b, each articulated arm is secured by at least one screw 313 passing through a hole in the plate 32 of the box and located opposite a captive nut or a tapped hole of said articulated arm, as shown in the figures. Advantageously, in particular to obtain a better embedding of the connection between the box and an articulated arm, at least one screw 313′ passes through a hole, not visible in the figures, in an upper wall of said box and located opposite a captive nut or a threaded hole of said articulated arm.

In a fourth step of the conversion, the fasteners securing the box 30 to the supports 241, 242 of the structure of the sitting surface, namely the four screws 322 in the case illustrated, are removed so that the articulated arms are able to move said box that is no longer connected to an element other than said articulated arms.

In a step subsequent to the conversion, the elements of the seat, removed as a precaution in the previous step, are placed back on the seat structure converted into a seat with leg rest, the closure panel of the casing being replaced by the leg rest 40.

To perform the reverse conversion of a seat with leg rest in a seat without leg rest, the actions performed during the conversion are reversed and executed in the reverse order of that previously discussed:

in the stored position of the leg rest, the casing 30 is secured to the structure of the sitting surface by means of the screws 322 passing through the holes 321;

the fasteners 313, 313′ holding the casing 30 to the articulated arms 315 are removed so that said articulated arms and said casing are no longer held attached directly to each other;

the active front plate 22b is detached from the structure of the sitting surface by removing the corresponding fasteners, namely the four screws 222 in the example illustrated, then said active front plate is removed;

the passive front plate 22a is finally attached to the structure of the sitting surface at the location freed by the active front plate by replacing fasteners at the locations provided.

The method, whose identified steps are here the essential steps in the order in which they must be carried out for the conversions, but which may comprise other steps not specified here, thus makes it possible to convert a seat in a particularly effective way by removing and installing some screws (eight or twelve in the example), without the need to use special tooling and without requiring particular adjustments.

These advantages are made possible by a particular architecture of the seat and its structure and by the implementation of a conversion kit limited to a front plate, equipped or not with an actuator and articulated arms.

The manufacturing and maintenance costs of such a convertible seat are advantageously reduced by increasing the series produced and by reducing the number of spare parts required for operation.

The conversion costs and the downtime of the seats are also reduced because of the reduced number of operations to be carried out on each seat and this result is achieved without penalizing the mass and the cost of the seat in its simplest form without the leg rest.

What is claimed is:

1. A seat comprising a sitting surface, said sitting surface having a surface to support a cushion of the sitting surface attached to a structure of said sitting surface, and a box, said box comprising a casing placed under the cushion support surface of the sitting surface, characterized in that the box can be secured so as to remain stationary on the structure of the sitting surface or removably secured with respect to the structure of the sitting surface by means of one or a plurality of articulated arms about an axis of rotation, oriented in a lateral direction Y, with respect to the structure of the sitting surface, and in that the box has a plurality of locations for attachments, said set comprising:
a first subset of a plurality of attachment locations wherein each attachment location is located, when the box is in a stored position, opposite a fixed attachment point on the structure of the sitting surface; and
a second subset of a plurality of attachment locations, all distinct from the attachment locations of the first subset, wherein each attachment location is located, when the box is in a stored position, opposite an attachment point on an articulated arm with respect to the structure of the sitting surface when the seat is provided with articulated arm(s).

2. The seat according to claim 1, wherein, when the seat is in use, the box is secured to the structure of the sitting surface by one or more fasteners placed at the attachment locations of the first subset, excluding the attachment locations of the second subset.

3. The seat according to claim 2, wherein a passive front plate, forming all or part of the cushion support surface of the sitting surface, is secured to the structure of the sitting surface on the side of a front edge of the sitting surface.

4. The seat according to claim 1, comprising one or more articulated arms, wherein, when the seat is in use, the box is secured to said articulated arm(s) by fasteners placed at the attachment locations of the second subset, excluding the attachment locations of the first subset.

5. The seat according to claim 4, wherein an active front plate, comprising a support plate forming all or part of the cushion support surface of the sitting surface, is secured to the structure of the sitting surface on the side of a front edge of the sitting surface, and to which support plate are fixed the articulated arm(s) and an actuator, arranged to modify a position of the box (30) secured to the articulated arm(s).

6. The seat according to claim 4, wherein the casing of the box is closed by a leg rest secured to a front face of said box, the position of said leg rest relative to the sitting surface resulting from the position of said box, modifiable by the actuator.

7. The seat according to claim 3, without a leg rest and comprising a passive front plate.

8. The seat according to claim 5, comprising a leg rest and an active front plate.

9. The seat in which the structure of the sitting surface comprises attachment housings for alternately mounting a passive front plate conforming to the passive front plate of the seat of claim 3.

10. The seat according to claim 9, wherein the same attachment housings of the structure of the sitting surface are implemented to secure said structure of the sitting surface by removable fasteners, alternately the passive front plate and the active front plate, said passive front plate and active front plate being mechanically interchangeable.

11. The seat according to claim 9, comprising at least one rear plate forming a portion of the cushion support surface of the sitting surface, said plate being secured to the structure of the sitting surface independently of the passive front plate or the active front plate, as appropriate.

12. A method for converting a seat, wherein a seat without a leg rest is converted into a seat with a leg rest, or conversely, a seat with a leg rest is converted into a seat without a leg rest, said conversion method comprising a step in which the box is secured simultaneously to the structure of the sitting surface and to at least one articulated arm with respect to the structure of the sitting surface.

13. The conversion method according to claim 10 of a seat without leg rest into a seat with leg rest comprising the steps of:
disassembling a passive front plate secured to the structure of the sitting surface; then
securing an active front plate, equipped with an actuator of the leg rest and with one or more articulated arm(s), to the structure of the sitting surface at the location left free by the passive front plate disassembled in the previous step; then
securing the articulated arms to the box, maintained fixed to the structure of the sitting surface; then
removing the fasteners securing the box to the structure of the sitting surface.

14. The conversion method according to claim 10 of a seat with leg rest into a seat without leg rest comprising the steps of:
placing the leg rest in a stored position; then
securing the box to the structure of the sitting surface; then
disengaging the articulated arm(s) from the box; then
disassembling an active front plate supporting an actuator of the leg rest and the articulated arms; then
securing the passive front plate to the structure of the sitting surface at the location left free by the active front plate disassembled in the previous step.

15. The seat in which the structure of the sitting surface comprises attachment housings for alternately mounting a passive front plate conforming to the passive front plate of the seat of claim 7.

16. The seat in which the structure of the sitting surface comprises attachment housings for alternately mounting a passive front plate conforming to an active front plate conforming to the active front plate of claim 5.

17. The seat in which the structure of the sitting surface comprises attachment housings for alternately mounting a passive front plate conforming to an active front plate conforming to the active front plate of claim 8.
